(19) United States
(12) Patent Application Publication
(10) Pub. No.: US 2007/0256987 A1
(43) Pub. Date: Nov. 8, 2007

(54) Chemically-enhanced mechanical treatment of water

(76) Inventors: Freddie L. Singleton, Switzerland, FL (US); Michael J. Mayer, Jacksonville, FL (US); Alexander W. Breen, Richmond Hill, GA (US)

Correspondence Address: Joanne Mary Fobare Rossi;Hercules Incorporated, Hercules Plaza, 1313 North Market Street, Wilmington, DE, 19894-0001, US

(21) Appl. No.: 11/641,438

(22) Filed: Dec. 19, 2006

Related U.S. Application Data
(60) Provisional application No. 60/752,168, filed on Dec. 19, 2005.

(51) Int. Cl. C02F 1/50; C02F 1/68

(52) U.S. Cl. 210/764

(57) ABSTRACT

The present invention describes a method of treating an aqueous system with a hydrodynamic water treatment device in conjunction with a surfactant.

### CROSS REFERENCE TO RELATED APPLICATIONS

This application is related to U.S. patent application Ser. No. 60/752,168, filed Dec. 19, 2005, from which priority is claimed, the foregoing application is hereby incorporated by reference.

### TECHNICAL FIELD

The present invention relates to enhancing inhibition of microorganisms by hydromechanical treatment of water and the use of surface-active chemicals to inhibit or control growth of microorganisms in aqueous systems.

### BACKGROUND OF THE INVENTION

In the absence of extreme environmental conditions, microorganisms are ubiquitous in natural and man-made aqueous systems. The size and complexity of a microbial community in an aqueous system will depend on many factors from the physico-chemical parameters (available nutrients, temperature, pH, etc.) of the water to prevailing environmental parameters of the surrounding ecosystem. Industrial water systems can provide an environment suitable for growth of bacteria and other types of microorganisms. Uncontrolled growth of microorganisms in process water can result in large numbers of free-floating (planktonic) cells in the water column and sessile cells on submerged surfaces where conditions favor formation of biofilms.

Regardless of the system, whether natural or man-made, growth of microorganisms in aqueous systems can have serious consequences. For example, uncontrolled microbial growth can range from interference of important industrial processes to degradation and/or spoilage of products to contamination of products. Growth of microorganisms on surfaces exposed to water (e.g., recirculation systems, heat exchangers, once-through heating and cooling systems, pulp and paper process systems) can be especially problematic. Microbiologically-influenced problems in industrial process waters include accelerated corrosion of metals, accelerated decomposition of wood and other biodegradable materials, restricted flow through pipes, plugging or fouling of valves and flow-meters, and reduced heat exchange or cooling efficiency on heat exchange surfaces. Biofilms may also be problematic relative to cleanliness and sanitation in medical equipment, breweries, wineries, dairies and other industrial food and beverage process water systems.

In order to control problems caused by microorganisms in industrial process waters, numerous antimicrobial agents (i.e., biocides) and other compounds, especially surface-active materials (e.g., surfactants) have been employed. Because of safety and health concerns as well as cost and other considerations, alternatives to biocides have been investigated. Surfactants have been used as surface cleaners or biodispersants because of their ability to remove chemical or biological deposits from surfaces. When used as a cleaner or biodispersant, surfactants are usually added directly to a process water stream or to a material used in the process. The typical method of addition is such that the surfactant is distributed within a certain region of the process system to either clean surface or prevent the surface from being contaminated with chemical or biological materials.

Technologies that do not include adding chemicals to treat industrial process waters have been the subject of investigation and development. Many non-chemical water technologies have been developed and the general categories for such technologies include, among others, ultraviolet light and ozone (for disinfecting water), ultrasound (or sonication), electric and electromagnetic fields, including pulsed electrical fields, and applying hydromechanical forces to the water.

Hydromechanical water treatment is based on the premise that changes in the chemical composition and other physico-chemical parameters of water occur during treatment. One such technology, marketed by VRTX Technologies, (San Antonio, Tex.) is based on inducing chemical changes in water via hydrodynamic cavitation. This technology treats industrial process waters, primarily in cooling towers to prevent corrosion, scale formation, and deposition.

Hydrodynamic cavitation refers to a process wherein cavities and cavitation bubbles filled with a vapor-gas mixture are formed inside the fluid flow. Cavitation bubbles can also be formed at the boundary of a baffle body because of a local decrease in pressure in the fluid. A great number of vapor-filled cavities and bubbles form if the pressure decreases to a level where the fluid boils. As the fluid and cavitation bubbles flow in a system, they encounter a zone with higher pressure at which point, vapor condensation occurs within the bubbles and the bubbles collapse. The collapse of cavitation bubbles can cause very large pressure impulses. For example, the pressure impulses within the collapsing cavities and bubbles can be tens of thousands of pounds per square inch. The result of hydrodynamic cavitation and other forces exerted on the water range from changes in solubility of dissolved gases to pH changes to formation of free radicals to precipitation of some dissolved ions (e.g., calcium, iron, and carbonate).

Systems designed to induce hydrodynamic cavitation in fluids traditionally have been used as homogenization devices or colloidal mills. Examples of homogenization devices have been described by Ashbrook et al. (U.S. Pat. Nos. 4,645,606; 4,764,283; 4,957,626), Ashbrook (U.S. Pat. Nos. 5,318,702; 5,435,913). Kozyuk (U.S. Pat. Nos. 6,802,639 and 6,502,979) discloses a homogenization device that forms emulsion or colloidal suspensions that have long separation half-lives by use of cavitating flow. Thiruvengadam et al. (U.S. Pat. No. 4,127,332) discloses a system for homogenizing a multi-component stream including a liquid and a substantially insoluble component, which may be either a liquid or a finely divided solid.

A hydromechanical water treatment system based on hydrodynamic cavitation can be used to inhibit or kill macroorganisms and microorganisms in an aqueous system as a result of high shear, hydrodynamic cavitation forces, and other hydrodynamic changes in the aqueous system as it passes through the treatment system. Relative to microorganisms, e.g., bacteria and fungi, the shear and hydrodynamic forces can cause lysis of the cells. Most methods used to lyse bacterial and fungal cells are based on cavitation and shear effects. For example, ultrasound has been used to induce cavitation in liquids and, as a result, lysis of cells occurs. Other mechanical methods used in the past to disrupt cells have included ball mills, the application of high pressure followed by passage through a small diameter orifice, and violent vibration with inert particulates. These and other methods to physically disrupt microbial cells are described by Schnaitman, C. A., “Cell Fractionation,” Manual of Methods for General Bacteriology, Ch. 5, 52-61 (Gerhardt, P. et al., Eds. 1981), Coakley W. T. et al., “Disruption of Microorganisms,” Adv. Microbiol. Physiol. 16:279-341 (1977). Such methods to disrupt microbial cells have been designed and used to isolate specific cellular components such as protein, nucleic acids, and the like. However, such technologies are not practical for treating large volumes of water usually present in industrial settings.

There remains a need to improve efficiency of the hydrodynamic devices to control microorganisms in aqueous systems, particularity in industrial process waters.

### SUMMARY OF THE INVENTION

It has surprisingly been found that when at least one surfactant or combinations of surfactants are used in conjunction with a hydrodynamic-based water treatment system an unexpectedly large increase in the effectiveness of the system is observed. The quantity of microbiological organism in the water being treated by the present invention is greatly decreased as compared to using the hydrodynamic-based water treatment system without the surfactants or combinations of surfactants.

The present invention provides a method for controlling microorganisms in industrial process water by treating the water with an effective amount of at least one or more surfactants and a hydrodynamic-based water treatment device.

### DETAILED DESCRIPTION OF THE INVENTION

The present invention is directed to using one or more surfactants in combination with a hydrodynamic water treatment device to inhibit or control the growth of microorganisms in an aqueous system. Using a hydrodynamic water treatment device with a surfactant or combination of surfactants allows for inhibiting or controlling growth of microorganisms without the use of a toxic or biocidal material. The present invention is suited for use in industrial water systems.

The hydrodynamic water treatment device is generally operated in the range of 50 to 200 psi, preferably in the range of 80 psi to 140 psi, more preferably in the range of 85 to 120 psi.

The flow rate will depend on the hydrodynamic water treatment device used. The flow rate can be as low as 50 gpm. The flow rate can be as high as 1500 gpm. The flow rate of the hydrodynamic water treatment device, in generally, is in the range of about 80 to 1000 gpm. The flow rate is based on the hydrodynamic water treatment device, its configuration, the pumps, the chamber of the device and the orifice setting of the device.

The water being treated is generally recycled through the hydrodynamic water treatment device. The water is recycled through the hydrodynamic water treatment device a number of times to achieve the desired microorganism inhibition. The number of passes through the hydrodynamic water treatment device depends on the level and kind of microorganisms in the aqueous system being treated and the desired percent of inhibition. Some systems have only a few passes through the system to achieve acceptable level while other aqueous systems require a higher number to passes through the hydrodynamic water treatment device. Generally it is desirable to have the number of passes less than 100, even more desirable is to have the number of passes less then 50, and most desirable is to have the number of passes less than 30.

The dosage amounts of the surfactant or combinations of surfactants for use with a hydrodynamic water treatment device required for effectiveness in this invention generally depend on the nature of the aqueous system being treated, the level of organisms present in the aqueous system, and the level of inhibition desired. A person skilled in the art, using the information disclosed herein could determine the amount(s) necessary without undue experimentation.

In one embodiment of the present invention, the amount of surfactant added to a water system is in the range of 0.05 to 100 ppm based on the final concentration in the water being treated, preferably in the range of 0.1 to 10 ppm. The amount of surfactant can be as high as 1,000 ppm, preferable up to 100 ppm or more preferably up to 10 mg per liter. The amount of polymer is at least 0.01 ppm, preferably at least 0.1 ppm.

The use of the surfactants in conjunction with the hydrodynamic water treatment device increases the effectiveness of the hydrodynamic water treatment device.

It is believed that the hydrodynamic water treatment device produces the cavitation and/or increased shear in the water passing through the hydrodynamic water treatment device resulting in an inhibitory hydrodynamic effect wherein the microorganism are inhibited or killed.

As used herein, “inhibition” or “inhibit” refers to affecting microorganisms in a manner to render them unable to maintain viability, grow, reproduce, carryout normal metabolic activities, or adversely affect an industrial process water, the process for which the water is used, or the product produced.

For the purpose of the present invention, a hydrodynamic water treatment device is defined as a device designed to treat water by eliciting changes in one or more physico-chemical parameters of industrial process water by subjecting said water to high pressure and/or low pressure, and/or high flow rate, and/or high shear forces. The result of said treatment is changes in one or more parameters such as chemical composition, pH, temperature, concentration of dissolved gases, and number of viable microorganisms. The hydrodynamic water treatment device treats water by subjecting the water to hydrodynamic cavitation and/or high shear forces by pumping the water through components of the devise under conditions of high flow rate and pressure changes. It is understood that one or more of the conditions needed for hydrodynamic cavitation to occur also could be exploited as the basis for the invention described herein; such conditions include subjecting the liquid to regions of high pressure and low pressure while flowing at a high rate. It is also understood that high shear forces will be generated because of high flow rate and the nature of the device used.

As used herein, the term “microorganism” refers to any unicellular (including colonial) or filamentous organism. Microorganisms include all prokaryotes, fungi, protozoa, and some algae.

As used herein, “industrial process water” or “industrial water system” means water contained in recirculation and once through systems such as heat exchangers, heating and cooling systems, pulp and paper process systems, milk and dairy processing systems, food processing systems, and wastewater systems. It is obvious to one trained in the art that water contained in non-industrial systems could be also be treated according to the invention described herein. Such systems include, but are not limited to, aquatic systems such rivers, lakes, ponds, irrigation and retention ponds, fishponds, millponds, impoundments, lagoons, fountains, and reflecting and swimming pools. Pulp and paper process systems include, but are not limited to, whitewater, clarification units, wastewater treatment, intake water, either from a natural source(lake or stream) or public water source, and makedown water.

Generally, the surfactants useful in the present invention, used by themselves, are not known to provide any substantial inhibition of microbiological organisms. However, used in conjunction with a hydrodynamic water treatment device, the surfactants greatly enhance the effectiveness of the hydrodynamic water treatment device in controlling or killing the microorganisms.

The present invention provides a method of treating water systems, particularly industrial water systems to inhibit or kill microbiological growth. The method comprises treating the industrial water with a hydrodynamic water treatment device and contacting the industrial water with at least one surfactant. In one embodiment the surfactant is added to the industrial water prior to treating the water with the hydrodynamic water treatment device.

The surfactant can be added at intervals during the treatment of the water with the hydrodynamic water treatment device. In one embodiment the surfactant is added to the water being treated with the hydrodynamic water treatment device at discrete intervals during the treatment.

In one embodiment of the invention the surfactant is added to the water being treated both before the treatment with the hydrodynamic water treatment device and at discrete interval during the treatment of the water.

The surfactant can be added continuously to the water being treated during the treatment of the water with the hydrodynamic water treatment device.

The surfactant is present in the water being treated while the water is being treated by the hydrodynamic water treatment device.

Surfactants for use in combination with a hydrodynamic water treatment device include surfactants that can be classified as cationic, anionic, non-ionic, or amphoteric.

Surface active agents (usually referred to as surfactants) are amphipathic molecules that consist of a non-polar hydrophobic portion, usually a straight or branched hydrocarbon or fluorocarbon chain containing 8-18 carbon atoms, which is attached to a polar or ionic portion (hydrophilic). The hydrophilic portion can, therefore, be nonionic, ionic or amphoteric (also referred to as zwitterionic), and accompanied by counter ions in the last two cases. The hydrocarbon chain interacts weakly with the water molecules in an aqueous environment, whereas the polar or ionic head group interacts strongly with water molecules via dipole or ion-dipole interactions. This strong interaction with the water molecules renders the surfactant soluble in water. However, the cooperative action of dispersion and hydrogen bonding between the water molecules tends to squeeze the hydrocarbon chain out of the water and hence these chains are referred to as hydrophobic.

Surface active agents, “surfactants”, are used in the present invention. Surfactants are materials that have a tendency to absorb at surfaces and interfaces. This is a fundamental property of a surfactant, with the stronger the tendency to accumulate at the interface, the better the surfactant. An interface is the boundary between two immiscible phases.

The surfactant concentration at the interface is dependent on the structure (chemical and physical) of the surfactant as well as the nature of the two phases that form the interface. Surfactants are said to be amphiphilic, indicating that they consist of at least two parts, one that is soluble in a specific fluid and one that is insoluble in the same fluid. If the fluid is water, the two parts of a surfactant are referred to as hydrophilic and hydrophobic. The hydrophilic part of a surfactant is referred to as the polar head group because it has a tendency to be soluble in water. The hydrophobic part of a surfactant is that portion of the molecule that has a tendency to be insoluble in water.

Surfactants are classified according to their chemical composition and characteristics, especially the charge of the polar head group. The major classes of surfactants are anionic, cationic, non-ionic, and zwitterionics.

Surfactants can be synthetic materials, natural materials, or derivatives of natural materials. Examples of synthetic materials include, but are not limited to, functionalized siloxanes, fluorinated and perfluorinated products such as perfluorinated alcohols, and polyoxyalkylenes such as the ethylene oxide and/or propylene oxide adducts of alkylphenols, the ethylene oxide and/or propylene oxide adducts of long chain alcohols or fatty acids, mixed ethylene oxide/propylene oxide block copolymers. Examples of surfactants based on derivatives of natural materials include, but are not limited to, sorbitan fatty acid esters, ethoxylated sorbitan fatty acid esters, polyethoxylated sorbitan fatty acid esters, ethoxylated alcohols fatty amine oxides, and glycerol esters. Exemplary surfactants are, but not limited to, sorbitan monooleate, sorbitan sequioleate, sorbitan trioleate, polyoxyethylene sorbitan monooleate, sodium isostearyl-2-lactate, mixtures thereof, and the like.

Polymeric surfactants can be used in the present invention. Polymeric surfactants include molecules where hydrophobic chains grafted into a hydrophobic backbone polymer, hydrophilic chains grafted into a hydrophobic backbone, and alternating hydrophobic and hydrophilic segments. They key differentiating factor for a polymeric surfactant is that both the hydrophobic and hydrophilic segments are polymeric. This is to differentiate the molecule from structure where a polymeric hydrophilic segment is linked to a hydrophobic segment. Examples of this structure include, but are not limited to ethoxylated fatty acids and ethoxylated alcohols. Exemplary diblock and triblock polymeric surfactants include, but are not limited to, diblock and triblock copolymers based on polyester derivatives of fatty acids and poly[ethylene oxide] (e.g., Hypermer® B246SF, Uniqema, New Castle, Del.), diblock and triblock copolymers based on polyisobutylene succinic anhydride and poly[ethylene oxide], reaction products of ethylene oxide and propylene oxide with ethylenediamine, mixtures of any of the foregoing and the like.

Certain anionic surfactants can be used with the invention described herein. Specific examples of anioninc surfactants include, but are not limited to, alkyl polyoxyethylene sulfates, cholic acid and other bile acids (e.g., cholic acid, deoxycholic acid, glycocholic acid, taurocholic acid, glycodeoxycholic acid) and salts thereof (e.g., sodium deoxycholate, etc.), dioctyl sodium sulfosuccinate, glyceryl esters, phosphatidic acid and their salts, potassium laurate, sodium alginate, sodium carboxymethylcellulose, sodium dodecylsulfate, and sodium lauryl sulfate.

The alkyl and alkyl ether sulfates that can be useful in the present invention are represented by the formulae R—OSO₃.M and RO(C₂H₄O)ₓSO₃ M wherein R is alkyl or alkenyl of about 8 to about 22 carbon atoms, x is 1 to 10, and M is a water-soluble cation (e.g., ammonium, sodium, or potassium). The alkyl ether sulfates useful in the present invention are condensation products of ethylene oxide and monohydric alcohols having about 8 to about 22 carbon atoms. Preferably, R has 10 to 18 carbon atoms in both the alkyl and alkyl ether sulfates. The alcohols can be synthetic or can be derived from fats, e.g., coconut oil or tallow. Lauryl alcohol and straight chain alcohols are those derived from coconut oil. Such alcohols are reacted with from about 1 to about 10, and preferably about 3, molar proportions of ethylene oxide. As an example, when such alcohols are reacted with about 3 molar portions of ethylene oxide, the resulting mixture of molecular species, having, for example, an average of 3 moles of ethylene oxide per mole of alcohol, it is then sulfated and neutralized.

Specific examples of alkyl ether sulfates for use with the present invention include, but are not limited to, sodium coconut alkyl trioxyethylene sulfate, lithium tallow alkyl trioxyethylene sulfate, and sodium tallow alkyl hexaoxyethylene sulfate. Highly preferred alkyl ether sulfates are those comprising a mixture of individual compounds, said mixture having an average alkyl chain length of from about 8 to 20 carbon atoms and an average degree of ethoxylation of from about 1 to 4 moles of ethylene oxide.

Suitable cationic surfactants are, in particular, aliphatic and heterocyclic quaternary ammonium compounds and quaternary phosphonium compounds which contain at least one long-chain C₈₋₁₈ alkyl group at the quaternary center. Examples of such cationic surfactants are (hydrogenated tallow)benzyldimethylammonium chloride, coco(fractionated)benzyldimethylammonium chloride, cocoalkylbenzyldimethylammonium chloride, cocobenzyldimethylammonium chloride, di(ethylene hexadecanecarboxylate)dimethylammonium chloride, di(hydrogenated tallow)benzylmethylammonium chloride, di(hydrogenated tallow)dimethylammonium chloride, dicocodimethylammonium chloride, didecyldimethylammonium chloride, dihexadecyl dimethylammonium chloride, dioctadecyl dimethylammonium chloride, dioctyidimethylammonium chloride, dioleyidimethylammonium chloride, N-octadecyl-N-dimethyl-N′-trimethyl-propylene-diammonium dichloride, octadecyl trimethylammonium chloride, stearyldimenthylbenzyl ammonium chloride, dodecyltrimethylammonium chloride, nonylbenzylethyidimethyl ammonium nitrate, tetradecylpyridinium bromide, laurylpyridinium chloride, cetylpyridinium chloride, laurylpyridinium chloride, laurylisoquinolium bromide, ditallow(Hydrogenated)dimethyl ammonium chloride, dilauryidimethyl ammonium chloride, stearalkonium chloride, and tributyltetradecylphosphonium chloride.

Preferred cationic surfactants are, in particular, aliphatic and heterocyclic quaternary ammonium compounds and quaternary phosphonium compounds which contain at least one long-chain C₈₋₁₈ alkyl group at the quaternary center. Examples of such cationic surfactants are cocoalkyl benzyl dimethyl ammonium chloride, dioctyl dimethyl ammonium chloride, and tributyl tetradecyl phosphonium chloride. Suitable amphoteric surfactants are, in particular, C₈₋₁₈ fatty aid amide derivatives of betaine structure, more particularly derivatives of glycine, for example, cocoalkyl dimethyl ammonium betaine.

Suitable amphoteric surfactants are, in particular, C₈₋₁₈ fatty aid amide derivatives of betaine structure. Preferred derivatives of the betaine structure includes, but not limited to, coco dimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl, oleyl dimethyl gamma-carboxypropyl betaine, lauryl bis-(2-hydro-xypropyl)alpha-carboxyethyl betaine, coco dimethyl sulfopropyl betaine, stearyl dimethyl sulfopropyl betaine, amido betaines, and amidosulfobetaines. Other examples of amphoteric surfactants include derivatives of aliphatic secondary and tertiary amines in which the aliphatic radical can be straight chain or branched and wherein one of the aliphatic substituents contains from about 8 to about 24 carbon atoms and one of the aliphatic substituents contains an anionic water-solubilizing group. Preferred water solubilizing groups include carboxy, sulfonate, sulfate, phosphate, and phosphonate.

Non-ionic surfactants can be used in the present invention. Non-ionic surfactants have either a polyether or a polyhydroxyl moiety as the polar group. Examples of non-ionic surfactants include, but not limited to, sucrose esters, sorbitan esters, polyoxyethylene sorbitan fatty acid esters, alkyl glucosides, glycerol and polyglycerol esters, glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, glyceryl esters, and polyvinylpyrrolidone, alkyl phenols, polyoxyethylene fatty alcohol ethers, polyoxyethylene fatty acid esters, and alkanolamines and alkanolamides. Examples of non-ionic surfactants also include, but are not limited to, stearamido propyl dimethyl amine, diethyl amino ethyl stearamide, dimethyl stearamine, dimethyl soyamine, soyamine, tridecyl amine, ethyl stearylamine, ethoxylated (2 moles ethylene oxide) stearylamine, dihydroxyethyl stearylamine, and arachidylbehenylamine. Suitable non-ionic surfactant amine salts include the halogen, acetate, phosphate, nitrate, citrate, lactate, and alkyl sulfate salts. Such non-ionic surfactant salts include, but are not limited to, stearylamine hydrochloride, soyamine chloride, stearylamine formate, N-tallowpropane diamine dichloride, stearamidopropyl dimethylamine citrate, stearamido propyldimethyl amine, and guar hydroxypropyl triammonium chloride.

Preferred nonionic surfactants are the addition products of long-chain alcohols, alkyl phenols, amides and carboxylic acids with ethylene oxide (EO) and optionally together with propylene oxide (PO). These include, for example, the addition products of long-chain primary and secondary alcohols containing 12 to 18 carbon atoms in the chain, more particularly fatty alcohols and oxo alcohols of this chain length, with 1 to 20 moles EO and the addition products of fatty acids containing 12 to 18 carbon atoms in tie chain with preferably 2 to 8 moles ethylene oxide. The mixed addition products of ethylene and propylene oxide and C₁₂₋₁₈ fatty alcohols, more especially those containing about 2 moles EO and about 4 moles PO in the molecule are particularly preferred.

Non-ionic surfactants can be grouped according to their HLB value. For the purpose of the present invention, HLB is defined as the hydrophilic/lipophilic balance wherein the HLB value is an indication of the oil or water solubility of the surfactant. For example, the lower the HLB value the more oil soluble the product, and, in turn, the higher the HLB value the more water-soluble the product. Non ionic surfactants useful in the present invention can have an HLB value of from about 1 to about 20, preferably from about 2 to about 10 and most preferable from about 4 to about 7.

Certain amphoteric surfactants (also referred to as “zwitterionic” surfactants) can be used with the present invention. The chemical charge of amphoteric surfactants is dependent on the pH of the solution in which they are dissolved. In an acid pH solution, the molecule acquires a positive charge and behaves like a cationic surfactant, but it becomes negatively charged and behaves like an anionic surfactant in an alkaline pH solution. Zwitterionic or amphoteric surfactants that can be used with the present invention include, but are not limited to, those that can be broadly described as derivatives of aliphatic quaternary ammonium, phosphonium, and sulfonium compounds, in which the aliphatic radicals can be straight chain or branched, and wherein one of the aliphatic substituents contains from about 8 to 22 carbon atoms and one contains an anionic water-solubilizing group, such as a carboxy, sulfonate, sulfate, phosphate, or phosphonate group. Lecithin represents a preferred type of amphoteric surfactant for use in the present invention. Lecithins are mixtures of phospholipids, i.e., diglycerides of fatty acids linked to an ester of phosphoric acid. The preferred form of lecithin includes, but is not limited to diglycerides of stearic, palmitic, and oleic acids linked to the choline ester of phosphoric acid. Commercially available lecithins usually consist of pure phosphatidyl cholines or crude mixtures of phospholipids which include phosphatidyl choline, phosphatidyl serine, phosphatidyl ethanolamine, phosphatidyl inositol, other phospholipids, and other compounds such as fatty acids, triglycerides, sterols, carbohydrates, and glycolipids.

As used herein, the term “surfactant” refers to a material that can reduce the surface tension of water when used in very low concentrations and includes cationic surfactants, nonionic surfactants, anionic surfactants, and amphoteric surfactants.

### EXAMPLES

The “Experimental test system” used in the examples refers to a system comprised of a container or reservoir connected to a hydrodynamic water treatment device, “the VRTX system” via conduits for flow of a liquid from the reservoir to the hydrodynamic water treatment device and back into the reservoir.

The reservoir used in the studies reported herein was a polypropylene tank with a capacity of approximately 300 gallons. An opening near the bottom of the reservoir allowed it to be connected to the VRTX system via a 2-inch diameter pipe. Water exiting the VRTX system was returned to the reservoir via a 3-inch diameter pipe. To increase agitation of water in the reservoir, a submersible pump was placed in the middle of the reservoir. Water entered the submersible pump through the bottom and exited via a port on the top of the pump in an upward direction. The flow rate of the VRTX system was 80 gallons per minute (gpm). As described below, 80 gallons of water were used in each experiment. Therefore, for example, treating the water for 10 minutes allowed the total volume to pass through the hydrodynamic water treatment device 10 times.

As used herein, “VRTX system” refers to a non-chemical water treatment system available from VRTX Technologies, LLC (San Antonio, Tex.). The VRTX system is a hydrodynamic water treatment device and is based on a proprietary design whereby the intake stream of water is divided into two streams that enter a “reaction” chamber via nozzles that impact specific flow characteristics to the water streams. The chamber is designed to allow the water streams to enter from opposing points and collide in the center of the chamber. Because of the design of the nozzles and chamber, the water is subjected to hydrodynamic cavitation and high shear forces. The VRTX system used in the studies reported herein was one optimized for chemical treatment of industrial waters and, as such, the effect on microorganisms was less than if biological treatment of the water was an objective. It is obvious to one skilled in the art that there are other manners to induce hydrodynamic cavitation and high shear forces in order to treat water or other fluids.

As used herein, “basal salts solution” refers to solution prepared by first adding 15 ml of concentrated H₂SO₄ to 500 ml deionized water. The following chemicals were then dissolved in the dilute acid solution—KH₂PO₄ (6.0 g), MgSO₄ (1.2 g), AIKSO₄ (3.0 g), FeSO₄ (0.3 g), ZnSO₄ (0.3 g), and NaCl (1.5 g). Deionized water was added to increase the volume to 1.0 liter.

As used herein, “chemically defined water” means water used in the experimental test system prepared in the following steps: (1) filling the reservoir with 80 gallons of tap water; (2) neutralizing the residual chlorine by adding a minimal quantity of Na₂SO₃; chlorine was measured using the Hach DPD chlorine test kit (3) adding 1000 ml of basal salts solution; and (4) adjusting the pH of the water to 7.3 (+ or −0.2 pH unit) by adding 20% NaOH solution.

The Hach DPD chlorine test (Hach Company, Loveland, Colo.). Total available chlorine refers to the amount of chlorine in a sample that reacts with N,N-diethyl-ρ-phenylenediamine oxalate, the indicator used in the Hach assay. To determine the amount of chlorine in a sample, an aliquot of the sample is transferred to a clean container, diluted with deionized water, as appropriate, and assayed according to the Hach DPD chlorine test. The assay measures the total amount of chlorine that can react with the indicator reagent. The reaction is measured by determining the absorbance of light at 530 nm.

Following preparation of the chemically defined water, bacterial cells were added to an initial population density of approximately 1×10⁶ cells per milliliter. In most of the studies reported herein, Escherichia coli was used as the test species. In some experiments, papermill whitewater was used in lieu of the basal salts-tap water solution; when whitewater was used, the bacteria present in the water at the time of collection were used as the test species.

After the bacteria were added to the basal salts solution and allowed to circulate for 10-20 minutes to become evenly distributed in the water, a 1000 ml sample was aseptically collected and used as the control. This sample was maintained at room temperature on a magnetic stirrer and agitation was provided with a magnetic stir bar.

The efficacy of the treatment programs was determined based on changes in numbers of bacteria before and after the treatment program. Changes in numbers of bacteria were determined by employing the standard plate count technique. Samples of water were aseptically collected and serially diluted in 0.85% saline dilution blanks. One tenth milliliter samples of appropriate dilutions were aseptically transferred to tryptic soy agar plates and evenly distributed over the surface of the agar with a sterile bent glass rod. The agar plates were then incubated for 48 hours at 37° C. before the colonies were counted. The number of colonies is representative of the number of viable bacteria in the original water sample. The number of colonies is referred to as the “plate count” and is expressed as the number of colony-forming units (CFUs). In a typical experiment, the serial dilutions ranged from 10⁻² to 10⁻⁶. In all experiments, triplicate culture plates were prepared for each of three dilutions. Population sizes are reported as the average of the three plate counts.

The effect of the different treatment programs was determined based on percent difference in plate counts before and after treatment. Percent differences were calculated according to the equation:

$$\% change = \frac{\begin{matrix}( Plate count before treatment - \\ Plate count after treatment )\end{matrix}}{Plate count before treatment} \times 100$$

As used herein, “initial population size” refers to the number of bacteria per milliliter as determined by the plate count technique in the chemically defined water immediately before testing commenced.

As used herein, “final population size” refers to the number of bacteria per milliliter as determined by the plate count technique in the chemically defined water at the end of testing.

Additions of chemicals to the water were made in an incremental manner after selected treatment times. The amount of a chemical added is expressed in units of parts per million (ppm) (1 ppm=1 milligram per liter).

The designated amount in ppm of surfactant added to the chemically defined water or to papermill whitewater samples was based on the final concentration of the surfactant in the water.

The hydrodynamic water treatment device used in all the examples is the VRTX 80 (VRTX Technologies, San Antonio, Tex.) The VRTX 80 operates at about 80 gpm, the chamber pressure was about 100 psi. There is a vacuum of about −29 inches of Hg. The back pressure was set at about 2 to 4 psi.

The examples are intended to be illustrative of the present invention. However, these examples are not intended to limit the scope of the invention or its protection in any way. The examples illustrate the synergistic relationship obtained in the present invention.

### Example 1

This example demonstrates the effect of the hydrodynamic water treatment device, “the VRTX system”, on the size of the bacterial population in the experimental test system. As illustrated in Table 1, results from three experiments demonstrate the VRTX system has little measurable effect on the bacterial populations. The percent change in the population sizes for the three experiments are within the expected error for this type study.

TABLE 1
Effect of the hydrodynamic water treatment device on the numbers of
culturable Escherichia coli in a chemically defined water system.

| | | Total | | | |
|---|---|---|---|---|---|
| | Concentration(s) | Treatment | Initial | Final | |
| Experi- | and Contact | Time | Population | Population | Percent |
| ment | Time(s) | (min.) | Size | Size | Change |
| 1 | NA | 50 | 8.97 × 10⁵ | 9.33 × 10⁵ | 4.01 |
| 2 | NA | 50 | 5.97 × 10⁶ | 5.60 × 10⁶ | −6.20 |
| 3 | NA | 60 | 3.83 × 10⁶ | 4.20 × 10⁶ | 9.66 |

Table 1 shows that there was no significant effect of the hydrodynamic water treatment device, the VRTX system on population sizes of E. coli in the chemically defined water.

### Example 2

In this example, cationic surfactants were tested for effect on bacterial cells in water treated with and without the VRTX system. The results presented in Table 2 demonstrate that a range of effects was detected, depending on the nature of the specific surfactant. For example, 2-ppm cocoamine hydrochloride had a negligible effect on the E. coli population size in the absence of the VRTX system (Table 2). However, in the system treated with 2-ppm cocoamine hydrochloride and the VRTX system, the bacterial population decreased by 58.4% after a 40-minute treatment. A similar trend was detected when 3.0 ppm lauryl amine were added during the course of a 60-minute treatment; the E. coli population increased by 32.32% in the system treated with lauryl amine but decreased by 80.28% when lauryl amine was used in combination with the VRTX system. Duomeen® T (Akzo Nobel Chemicals, BV, Netherlands) a tallow alkyldiamine, caused significant decreases in the E. coli population whether or not the VRTX system was used. However, the larger decrease occurred in the system treated with the VRTX system.

TABLE 2
Changes in population sizes of Escherichia coli in chemically defined
water treated with cationic surfactants with and without the hydrodynamic water
treatment device.

| | | Total | Initial | Final | |
|---|---|---|---|---|---|
| | Concentration(s) | Treatment | Population | Population | Percent |
| Treatment | and Contact Time(s) | Time (min.) | Size | Size | Change |
| Cocoamine | 0.5 ppm for 10 min, | 40 | 2.08 × 10⁶ | 1.93 × 10⁶ | −7.36 |
| HCl | 1.0 ppm for 10 min., | | | | |
| | 1.5 ppm for 10 min., | | | | |
| | 2.0 ppm for 10 min. | | | | |
| Cocoamine | 0.5 ppm for 10 min, | 40 | 2.08 × 10⁶ | 8.67 × 10⁶ | −58.40 |
| HCl + VRTX | 1.0 ppm for 10 min., | | | | |
| | 1.5 ppm for 10 min., | | | | |
| | 2.0 ppm for 10 min. | | | | |
| Lauryl | 0.5 ppm for 10 min., | 60 | 1.88 × 10⁶ | 2.48 × 10⁶ | 32.32 |
| Amine | 1.0 ppm for 10 min., | | | | |
| | 1.5 ppm for 10 min., | | | | |
| | 2.0 ppm for 5 min., | | | | |
| | 2.5 ppm for 5 min., | | | | |
| | 3.0 ppm for 20 min. | | | | |
| Lauryl | 0.5 ppm for 10 min., | 60 | 1.88 × 10⁶ | 3.70 × 10⁵ | −80.28 |
| Amine + VRTX | 1.0 ppm for 10 min., | | | | |
| | 1.5 ppm for 10 min., | | | | |
| | 2.0 ppm for 5 min., | | | | |
| | 2.5 ppm for 5 min., | | | | |
| | 3.0 ppm for 20 min. | | | | |
| Duomeen T | 0.2 ppm for 10 min., | 40 | 1.64 × 10⁶ | 2.50 × 10⁵ | −84.75 |
| | 0.4 ppm for 10 min., | | | | |
| | 0.6 ppm for 10 min., | | | | |
| | 0.8 ppm for 10 min. | | | | |
| Duomeen T + VRTX | 0.2 ppm for 10 min, | 40 | 1.64 × 10⁶ | 1.70 × 10⁴ | −98.96 |
| | 0.4 ppm for 10 min., | | | | |
| | 0.6 ppm for 10 min., | | | | |
| | 0.8 ppm for 10 min. | | | | |
| Rhodameen | 1 ppm for 10 min., | 30 | 2.18 × 10⁶ | 2.30 × 10⁶ | 5.50 |
| PN430 | 2 ppm for 10 min., | | | | |
| | 3 ppm for 10 min. | | | | |
| Rhodameen | 1 ppm for 10 min., | 30 | 2.18 × 10⁶ | 1.83 × 10⁶ | −16.18 |
| PN430 + VRTX | 2 ppm for 10 min., | | | | |
| | 3 ppm for 10 min. | | | | |
| Mazeen C-2 | 0.1 ppm for 5 min, | 40 | 2.15 × 10⁶ | 1.89 × 10⁶ | −12.07 |
| | 0.2 ppm for 5 min., | | | | |
| | 0.3 ppm for 5 min., | | | | |
| | 0.4 ppm for 5 min., | | | | |
| | 0.5 ppm for 5 min., | | | | |
| | 0.6 ppm for 5 min., | | | | |
| | 1.6 ppm for 5 min., | | | | |
| | 2.6 for 5 min. | | | | |
| Mazeen C-2 + VRTX | 0.1 ppm for 5 min, | 40 | 2.15 × 10⁶ | 3.13 × 10⁶ | 14.55 |
| | 0.2 ppm for 5 min., | | | | |
| | 0.3 ppm for 5 min., | | | | |
| | 0.4 ppm for 5 min., | | | | |
| | 0.5 ppm for 5 min., | | | | |
| | 0.6 ppm for 5 min., | | | | |
| | 1.6 ppm for 5 min., | | | | |
| | 2.6 for 5 min. | | | | |

Rhodameen ® (Rhodia Chemie Corporation, Courbevoie France
Mazeen ® (BASF Corporation, Mt Olive, NJ) Fatty Amine Ethoxylate

### Example 3

Certain anionic surfactants were tested for their impact on the E. coli population in water treated with and without the VRTX system. Low concentrations of two anionic surfactants, Dowfax® 2A1 and sodium lauryl sulfate, showed minimal, if any, negative impact on the E. coli populations regardless of use of the VRTX system (Table 3). However, there was a greater reduction in numbers of E. coli in when the cell suspension was treated with 4 ppm of Oleic Isopropanolamide (Burlington Chemical Co.) and the VRTX system than the surfactant alone.

TABLE 3
Changes in population sizes of Escherichia coli in chemically defined
water treated with the indicated anionic surfactant with and without the
hydrodynamic water treatment device.

| | | Total | | | |
|---|---|---|---|---|---|
| | Concentration(s) | Treatment | Initial | Final | |
| | and Contact | Time | Population | Population | Percent |
| Treatment | Time(s) | (min.) | Size | Size | Change |
| Dowfax | 1 ppm for 10 min., | 30 | 3.77 × 10⁶ | 4.73 × 10⁶ | 25.66 |
| 2A1 | 2 ppm for 10 min., | | | | |
| | 3 ppm for 10 min. | | | | |
| Dowfax | 1 ppm for 10 min., | 30 | 3.77 × 10⁶ | 4.07 × 10⁶ | 7.96 |
| 2A1 + VRTX | 2 ppm for 10 min., | | | | |
| | 3 ppm for 10 min. | | | | |
| Sodium | 0.5 ppm for 10 min., | 20 | 1.38 × 10⁶ | 1.32 × 10⁶ | 13.29 |
| Lauryl | 1.0 ppm for 10 min. | | | | |
| Sulfate | | | | | |
| Sodium | 0.5 ppm for 10 min., | 20 | 1.38 × 10⁶ | 1.56 × 10⁶ | −4.35 |
| Lauryl | 1.0 ppm for 10 min. | | | | |
| Sulfate + VRTX | | | | | |
| Burcomide | 1 ppm for 10 min., | 50 | 1.79 × 10⁶ | 1.23 × 10⁶ | −31.23 |
| 61 | 2 ppm for 10 min., | | | | |
| | 3 ppm for 10 min., | | | | |
| | 4 ppm for 20 min. | | | | |
| Burcomide | 1 ppm for 10 min., | 50 | 1.79 × 10⁶ | 8.53 × 10⁵ | −52.42 |
| 61 + VRTX | 2 ppm for 10 min., | | | | |
| | 3 ppm for 10 min., | | | | |
| | 4 ppm for 20 min. | | | | |

Dowfax ® is an anionic surfactant Alkyldiphenyloxide Dsultonate from Dow Chemicals, Midland, Michigan
Burcomide is Burcomide ® 61 (Burlington Chemical Company, Burlington, NC) an Oleic Isopropanolamide.

### Example 4

Non-ionic surfactants representing a wide range of HLB values were evaluated. The results, presented in Table 4, indicate a general correlation between low HLB value and enhanced killing of E. coli in the experimental system (Table 3).

TABLE 4
Changes in population sizes of Escherichia coli in chemically defined
water treated with the indicated surfactant with and without the VRTX system.

| | Concentration(s) | Total | Initial | Final | |
|---|---|---|---|---|---|
| | and Contact | Treatment | Population | Population | Percent |
| Treatment | Time(s) | Time (min.) | Size | Size | Change |
| Surfonic | 0 ppm for 20 min., | 50 | 7.47 × 10⁶ | 6.63 × 10⁶ | −11.16 |
| L24.9 | 1 ppm for 10 min., | | | | |
| (HLB = 13) | 2 ppm for 10 min., | | | | |
| | 3 ppm for 10 min. | | | | |
| Surfonic | 0 ppm for 20 min., | 50 | 7.47 × 10⁶ | 6.23 × 10⁶ | −16.52 |
| L24.9 | 1 ppm for 10 min., | | | | |
| (HLB = 13) + VRTX | 2 ppm for 10 min., | | | | |
| | 3 ppm for 10 min. | | | | |
| Span 20 | 1 ppm for 10 min., | 40 | 1.40 × 10⁶ | 1.75 × 10⁶ | 24.70 |
| (HLB = 8.6) | 2 ppm for 10 min., | | | | |
| | 3 ppm for 10 min., | | | | |
| | 4 ppm for 10 min. | | | | |
| Span 20 + VRTX | 1 ppm for 10 min., | 40 | 1.40 × 10⁶ | 8.97 × 10⁵ | −36.10 |
| | 2 ppm for 10 min., | | | | |
| | 3 ppm for 10 min., | | | | |
| | 4 ppm for 10 min. | | | | |
| Surfonyl 440 | 1 ppm for 10 min., | 40 | 2.10 × 10⁶ | 2.05 × 10⁶ | −2.23 |
| (HLB = 8) | 2 ppm for 10 min., | | | | |
| | 3 ppm for 10 min., | | | | |
| | 4 ppm for 10 min. | | | | |
| Surfonyl 440 + VRTX | 1 ppm for 10 min., | 40 | 2.10 × 10⁶ | 2.22 × 10⁶ | 6.04 |
| | 2 ppm for 10 min., | | | | |
| | 3 ppm for 10 min., | | | | |
| | 4 ppm for 10 min. | | | | |
| Tergitol | 0 ppm for 10 min, | 30 | 2.63 × 10⁶ | 2.32 × 10⁶ | −12.03 |
| 15-S-3 | 1 ppm for 10 min., | | | | |
| (HLB = 8) | 2 ppm for 10 min. | | | | |
| Tergitol | 0 ppm for 10 min, | 30 | 2.63 × 10⁶ | 2.02 × 10⁶ | −23.29 |
| 15-S-3 + VRTX | 1 ppm for 10 min., | | | | |
| | 2 ppm for 10 min. | | | | |
| Surfonic | 0 ppm for 20 min., | 80 | 1.51 × 10⁸ | 1.73 × 10⁸ | 14.32 |
| L24-1.3 | 1 ppm for 20 min., | | | | |
| (HLB = 4.5) | 2 ppm for 20 min., | | | | |
| | 3 ppm for 20 min. | | | | |
| Surfonic | 0 ppm for 20 min., | 80 | 1.51 × 10⁸ | 1.33 × 10⁶ | −99.12 |
| L24-1.3 | 1 ppm for 20 min., | | | | |
| (HLB = 4.5) + VRTX | 2 ppm for 20 min., | | | | |
| | 3 ppm for 20 min. | | | | |
| Surfonic L61 | 1 ppm for 5 min., | 50 | 2.19 × 106 | 2.06 × 106 | −5.93 |
| (HLB = 1-7) | 2 ppm for 5 min., | | | | |
| | 3 ppm for 5 min., | | | | |
| | 4 ppm for 5 min., | | | | |
| | 5 ppm for 5 min., | | | | |
| | 6 ppm for 25 min. | | | | |
| Surfonic L61 | 1 ppm for 5 min., | 50 | 2.19 × 106 | 8.77 × 105 | −60.03 |
| (HLB = 1-7) + VRTX | 2 ppm for 5 min., | | | | |
| | 3 ppm for 5 min., | | | | |
| | 4 ppm for 5 min., | | | | |
| | 5 ppm for 5 min., | | | | |
| | 6 ppm for 25 min. | | | | |

Sulfonic ® (Huntsman Petrochemical Corporation, Salt Lake City, Utah) Nonionic alcohol ethoxylate
Span 20 Sorbitan Monolaurate
Surfynol ® 440 Air Products, Allentown, PA Non ionic Surfactant
Tergitol ® (Union Carbide Chemicals & Plastics Technology Corp., Midland, Michigan) is a non-ionic secondary alcohol ethoxylate

The results from Example 4 indicated a correlation between lower HLB value and increase killing of E. coli cells in the experimental system. The lower HLB values indicate that a surfactant has structural features that favor associating with hydrophobic materials or regions such as the interior of cell membranes.

### Example 5

Commercially available surfactants that are components of some type of cells membranes were evaluated for their ability to inhibit E. coli cells in the presence and absence of the VRTX system. Two commercially available lecithins were Centrophase C and Centrophase HR (The Solae Company, St. Louis Mo.), and a phospholipid (Arlasilk® PTC, Uniquema, Wilmington, Del.) were studied Centrophase C and Centrophase HR contain natural mixture of neutral and polar lipids, especially phosphatidylcholine. As illustrated in Table 5, neither lecithin source alone had significant adverse effects on the population size of E. coli in the chemically defined water. Incremental additions of a total of 21 ppm of Centrophase HR during a 60-minute treatment period resulted in only a 21.25% reduction in the E. coli population. Conversely, incremental additions of Centrophase C, up to a total of 7 ppm, resulted in an 86.87% reduction in the number of E. coli cells. The product literature for Centrophase C indicates this product has an HLB value of 4; this is consistent with aforementioned results on efficacy of surfactants with lower HLB values. The other amphoteric surfactant tested, Arlasilk® demonstrated antimicrobial activity with or without the VRTX system although considerably more killing was detected when the VRTX system was used (e.g., 60.07% killing with the surfactant alone but 90.07% killing with the surfactant and the VRTX system).

TABLE 5
Changes in population sizes of Escherichia coli in chemically defined
water treated with the indicated amphoteric surfactant with and without the
hydrodynamic water treatment device.

| | | Total | | | |
|---|---|---|---|---|---|
| | Concentration(s) | Treatment | Initial | Final | |
| | and Contact | Time | Population | Population | Percent |
| Treatment | Time(s) | (min.) | Size | Size | Change |
| Centrophase | 0 ppm for 15 min., | 60 | 2.09 × 10⁶ | 1.82 × 10⁶ | −12.94 |
| HR | 1 ppm for 5 min., | | | | |
| | 11 ppm for 20 min., | | | | |
| | 21 ppm for 20 min. | | | | |
| Centrophase | 0 ppm for 15 min., | 60 | 2.09 × 10⁶ | 1.64 × 10⁶ | −21.25 |
| HR + VRTX | 1 ppm for 5 min., | | | | |
| | 11 ppm for 20 min., | | | | |
| | 21 ppm for 20 min. | | | | |
| Centrophase C | 1 ppm for 25 min., | 75 | 2.46E × 10⁶ | 2.35 × 10⁶ | −4.60 |
| | 3 ppm for 30 min., | | | | |
| | 7 ppm for 20 min. | | | | |
| Centrophase | 1 ppm for 25 min., | 75 | 2.46 × 10⁶ | 3.23 × 10⁵ | −86.87 |
| C + VRTX | 3 ppm for 30 min., | | | | |
| | 7 ppm for 20 min. | | | | |
| PTC | 1 ppm for 10 min, | 50 | 2.75 × 106 | 1.10 × 106 | −60.07 |
| | 2 ppm for 10 min., | | | | |
| | 3 ppm for 10 min., | | | | |
| | 5 ppm for 20 min. | | | | |
| PTC + VRTX | 1 ppm for 10 min, 2 ppm | 50 | 2.75 × 106 | 1.90 × 105 | −93.08 |
| | for 10 min., 3 ppm | | | | |
| | for 10 min., 5 ppm | | | | |
| | for 20 min. | | | | |

### Example 6

Two surfactants were simultaneously added with and without the VRTX system to determine if the was enhanced inhibition of the bacterial cells in chemically defined water. For this example, cocoamine and Mona PTC were used. One part per million of each active was added to the system and, in the case of the VRTX system, water was processed for 10 minutes. After the 10-minute treatment period, there was a 14.57% decrease in the bacterial population in without the VRTX system, but a 32.45% decrease with the system.

TABLE 6
Changes in population sizes of Escherichia coli in chemically defined
water treated with cocoamine and Arlasilk ® PTC with and without a
hydrodynamic water treatment device.

| | | Total | | | |
|---|---|---|---|---|---|
| | Concentration(s) | Treatment | Initial | Final | |
| | and Contact | Time | Population | Population | Percent |
| Treatment | Time(s) | (min.) | Size | Size | Change |
| Cocoamine + Arlasilk ® | 1 ppm of each | 10 | 2.01 × 10⁶ | 1.72 × 10⁶ | −14.57 |
| PTC | for 10 min. | | | | |
| Cocoamine + Arlasilk ® | 1 ppm of each | 10 | 2.01 × 10⁶ | 1.36 × 10⁶ | −32.45 |
| PTC + VRTX | for 10 min. | | | | |

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A method for controlling the growth of microorganisms in water systems comprising the steps of:
a) adding an effective amount of at least one surfactant to the water system; and
b) treating the water system with a hydrodynamic-based water treatment device,
to inhibit the growth of the microorganisms.

2. The method of claim 1, wherein the hydrodynamic-based water treatment device creates hydrodynamic cavitation in the water passing through the hydrodynamic water treatment device.

3. The method of claim 1, wherein the wherein the hydrodynamic-based water treatment device creates shear in the water passing through the hydrodynamic water treatment device.

4. The method of claim 1, wherein the hydrodynamic-based water treatment device creates hydrodynamic cavitation and shear in the water passing through the hydrodynamic water treatment device.

5. The method of claim 1, wherein the water is industrial process water.

6. The method of claim 1 wherein the surfactant comprises at least one non-ionic surfactant.

7. The method of claim 6 wherein the non-ionic surfactant selected from the group consisting of sucrose esters, sorbitan esters, polyoxyethylene sorbitan fatty acid esters, alkyl glucosides, glycerol and polyglycerol esters, glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides, starch, starch derivatives, hydroxyethylstarch, polyvinyl alcohol, glyceryl esters, and polyvinylpyrrolidone, alkyl phenols, polyoxyethylene fatty alcohol ethers, polyoxyethylene fatty acid esters, and alkanolamines and alkanolamides, stearamido propyl dimethyl amine, diethyl amino ethyl stearamide, dimethyl stearamine, dimethyl soyamine, soyamine, tridecyl amine, ethyl stearylamine, ethoxylated (2 moles ethylene oxide) stearylamine, dihydroxyethyl stearylamine, and arachidylbehenylamine.

8. The method of claim 6 wherein the nonionic surfactant is a derivative of an amine salt selected from the group consisting of stearylamine hydrochloride, soyamine chloride, stearylamine formate, N-tallowpropane diamine dichloride, stearamidopropyl dimethylamine citrate, stearamido propyldimethyl amine, and guar hydroxypropyl triammonium chloride.

9. The method of claim 6 wherein the nonionic surfactant has an HLB value in the range of 1 and 20.

10. The method of claim 9 wherein the nonionic surfactant has an HLB value in the range of 2 to 10.

11. The method of claim 1 wherein the surfactant comprises at least one anionic surfactant.

12. The method of claim 11 wherein the anionic surfactant comprises a phospholipid selected from the group consisting of: phosphatidylcholine, phosphatidylethanolamine, phosphatidylserine, phosphatidylinositol, phosphatidylglycerol, phosphatidic acid, lysophospholipids, egg phospholipid and soybean phospholipid.

13. The method of claim 1 wherein the surfactant comprises at least one amphoteric surfactant.

14. The method of claim 13 wherein at least one amphoteric surfactant is selected from the group consisting of coco dimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl, oleyl dimethyl gamma-carboxypropyl betaine, lauryl bis-(2-hydro-xypropyl)alpha-carboxyethyl betaine, coco dimethyl sulfopropyl betaine, stearyl dimethyl sulfopropyl betaine, amido betaines, and amidosulfobetaines.

15. The method of claim 13 wherein at least one amphoteric surfactant is selected from the group consisting of derivatives of aliphatic secondary and tertiary amines in which the aliphatic radical can be straight chain or branched and wherein one of the aliphatic substituents contains from about 8 to about 24 carbon atoms and one of the aliphatic substituents contains an anionic water solubilizing group selected from the group consisting of carboxy, sulfonate, sulfate, phosphate, and phosphonate.

16. The method of claim 1 wherein the surfactant comprises at least one cationic surfactant.

17. The method of claim 1 wherein at least one cationic surfactant is selected from the group consisting of are (hydrogenated tallow)benzyldimethylammonium chloride, coco(fractionated)benzyldimethylammonium chloride, cocoalkylbenzyldimethylammonium chloride, cocobenzyldimethylammonium chloride, di(ethylene hexadecanecarboxylate)dimethylammonium chloride, di(hydrogenated tallow)benzylmethylammonium chloride, di(hydrogenated tallow)dimethylammonium chloride, dicocodimethylammonium chloride, didecyldimethylammonium chloride, dihexadecyl dimethylammonium chloride, dioctadecyl dimethylammonium chloride, dioctyidimethylammonium chloride, dioleyidimethylammonium chloride, N-octadecyl-N-dimethyl-N′-trimethyl-propylene-diammonium dichloride, octadecyl trimethylammonium chloride, stearyldimenthylbenzyl ammonium chloride, dodecyltrimethylammonium chloride, nonylbenzylethyldimethyl ammonium nitrate, tetradecylpyridinium bromide, laurylpyridinium chloride, cetylpyridinium chloride, laurylpyridinium chloride, laurylisoquinolium bromide, ditallow(Hydrogenated)dimethyl ammonium chloride, dilauryldimethyl ammonium chloride, stearalkonium chloride, and tributyltetradecylphosphonium chloride.

18. The method of claim 1 wherein two or more surfactants are added to the process water treated with a hydrodynamic water treatment device.

19. The method of claim 1 wherein the quantity of at least one surfactant added to the process water is in the range of 0.05 ppm to 100 ppm.

20. The method of claim 1 wherein the flowrate through the hydrodynamic-based water treatment device is from about 50 gpm to about 1500 gpm.

21. The method of claim 1 wherein the hydrodynamic-based water treatment operates at a pressure of from about 50 psi to about 200 psi.

22. The method of claim 1, wherein the water system is a pulp and paper process system.
